(19) United States
(12) Patent Application Publication
(10) Pub. No.: US 2005/0255272 A1
(43) Pub. Date: Nov. 17, 2005

(54) Peel-and stick message board calendar

(76) Inventor: Henry C. Query JR., Wheaton, IL (US)

Correspondence Address: Henry C. Query, Jr., 504 S. Pierce Avenue, Wheaton, IL, 60187, US

(21) Appl. No.: 11/128,783

(22) Filed: May 13, 2005

Related U.S. Application Data
(60) Provisional application No. 60/570,990, filed on May 14, 2004.

(51) Int. Cl. B32B 9/00

(52) U.S. Cl. 428/40.1

(57) ABSTRACT

A peel-and-stick message board calendar includes a top sheet which comprises a dry-erase surface, a backing sheet to which the top sheet is removably adhered, and a calendar graphic which is disposed on the top sheet and which comprises a plurality of spaces and a plurality of numbers. Each number represents an individual day of a corresponding period of time and is disposed in corresponding one of the spaces. In use, the top sheet may be peeled from the backing sheet and removably adhered to the dry-erase message board.

This application is based on and claims the benefit of U.S. Provisional Patent Application No. 60/570,990, which was filed on May 14, 2004.

### BACKGROUND OF THE INVENTION

The present invention is directed to a calendar for a dry-erase message board or the like. More particularly, the invention is directed to a calendar which is printed on a dry-erase sheet material that can be removably adhered to the message board to provide a convenient means for allowing date-specific information to be written on the message board.

Dry-erase message boards are commonly used in households and offices to temporarily record notes or other such messages. These message boards have a glossy front surface which can be written on with a dry-erase marker. Accordingly, when the messages are no longer relevant, they can be erased so that the message board can be reused.

Some dry-erase message boards have a calendar grid pre-printed on the glossy surface so that date-specific messages may be recorded near the corresponding day of the month. However, while the columns of these calendar grids are labeled with the names of the days of the week, the individual spaces of the calendar grids do not contain numbers corresponding to the days of the month. Instead, the days of the month must be printed by hand in the corresponding spaces. Although this allows the message board to be used for every month of any year, requiring the user to hand print the days of the month in each space can be inconvenient and may also lead to errors in dating the calendar.

### SUMMARY OF THE INVENTION

In accordance with the present invention, these and other limitations in the prior art are overcome by providing a peel-and-stick message board calendar which includes a top sheet which comprises a dry-erase surface and which is removably adherable to a dry-erase message board, a backing sheet to which the top sheet is removably adhered, and a calendar graphic which is disposed on the top sheet and which comprises a plurality of spaces and a plurality of numbers. Furthermore, each number represents an individual day of a corresponding period of time and is disposed in a corresponding one of the spaces.

Thus, the top sheet may be peeled from the backing sheet and adhered to the dry-erase message board, and date-specific messages may be written in the corresponding pre-numbered spaces. Therefore, no need exists for a user to hand print the days of the month in each space.

These and other objects and advantages of the present invention will be made apparent from the following detailed description, with reference to the accompanying drawings.

### BRIEF DESCRIPTION OF THE DRAWINGS

FIG. 1 is a representation of a set of monthly message board calendars of the present invention; and

FIG. 2 is a representation of a monthly message board calendar of the present invention shown applied to an exemplary dry-erase message board.

### DETAILED DESCRIPTION OF THE PREFERRED EMBODIMENTS

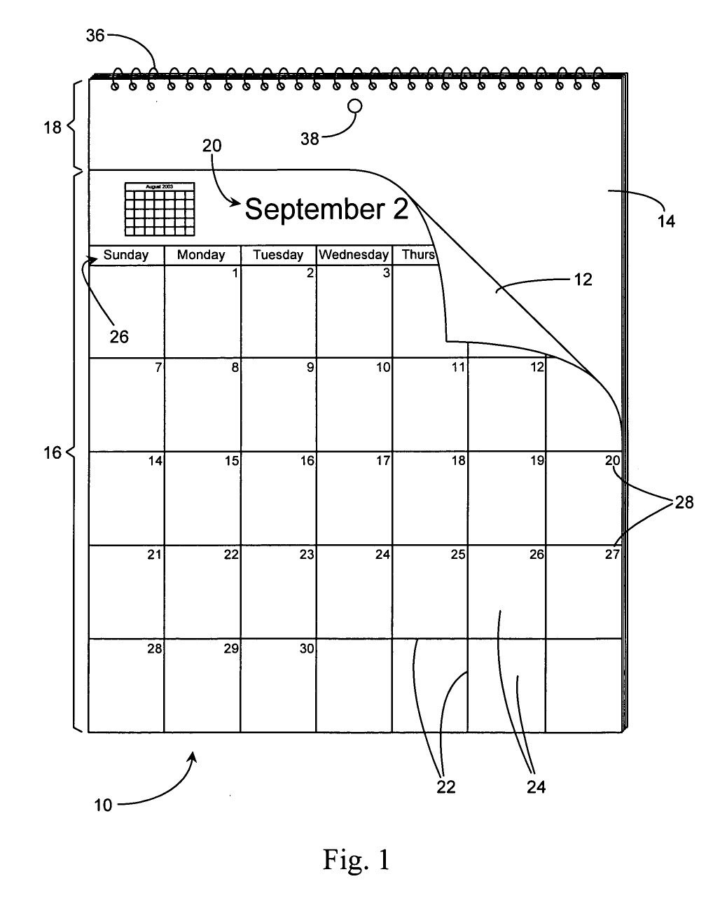

Referring to FIG. 1, the peel-and-stick message board calendar of the present invention, which is indicated generally by reference number 10, is shown to comprise a top sheet 12, a backing sheet 14 to which the top sheet is removably mounted, and a calendar graphic 16 which is printed on the top sheet.

The top sheet 12 is made of a flexible polymer material which has a smooth surface that can be written on with a dry-erase marker. In addition, the top sheet 12 is removably attachable by suitable means to the surface of a conventional message board. In one embodiment of the invention, the top sheet 12 is made from a conventional electrostatic, or “static cling”, vinyl sheet material. A top sheet 12 made from such a material is capable of adhering to the smooth, non-porous surface of the message board through electrostatic forces alone. Consequently, the top sheet 12 can be easily removed from the message board without leaving any adhesive residue behind. An example of one static cling vinyl sheet material which is suitable for use as the top sheet 12 is the Ultra Cling® static cling vinyl film which is available from HPS Inc. of Rhome, Tex.

The backing sheet 14 can be made from any suitable material to which the top sheet 12 is capable of being releasably adhered. In one embodiment of the invention, the backing sheet 14 is made from a relatively thin sheet of cardboard which has at least one of its faces treated to form a smooth, substantially non-porous surface. Accordingly, when the top sheet 12 is made from a static cling vinyl material, the top sheet will adhere electrostatically to the smooth, non-porous surface of the backing sheet 14. A suitable backing sheet 14 for the present invention is the backing sheet which is supplied with the Ultra Cling® static cling vinyl film identified above. Also, the backing sheet 14 may be sized slightly larger than the top sheet 12 so that the backing sheet includes a space 18 on which a desired message may be pre-printed.

The calendar graphic 16 can represent any desired period of time. In the embodiment of the invention shown in FIG. 1, for example, the calendar graphic 16 represents a specific month of a given year. Accordingly, the calendar graphic 16 is visually similar to an ordinary monthly calendar for a specific month. Thus, the calendar graphic 16 may include a month indicia 20 which designates the specific month to which the message board calendar 10 pertains, a grid 22 which comprises a plurality of individual spaces 24, a row of day indicia 26 which are indicative of the names of the days of the week, and a plurality of date indicia 28 which are indicative of the numbers of the days of the month and which are each located in a corresponding space to identify the calendar day which that space represents.

The calendar graphic 16 may be printed on the top sheet 12 using any suitable printing method, such as offset printing, lithography, inkjet printing or silk screening. In addition, the calendar graphic 16 may be printed using any appropriate non-erasable ink. If desired or required in order to make the calendar graphic 16 more durable, the top sheet 12 may be laminated with a suitable, preferably transparent material after the calendar graphic has been applied. Thus, the calendar graphic 16 will ideally remain on the top sheet 12 through repeated erasures of any messages which are written on the message board calendar 10 with a dry-erase marker.

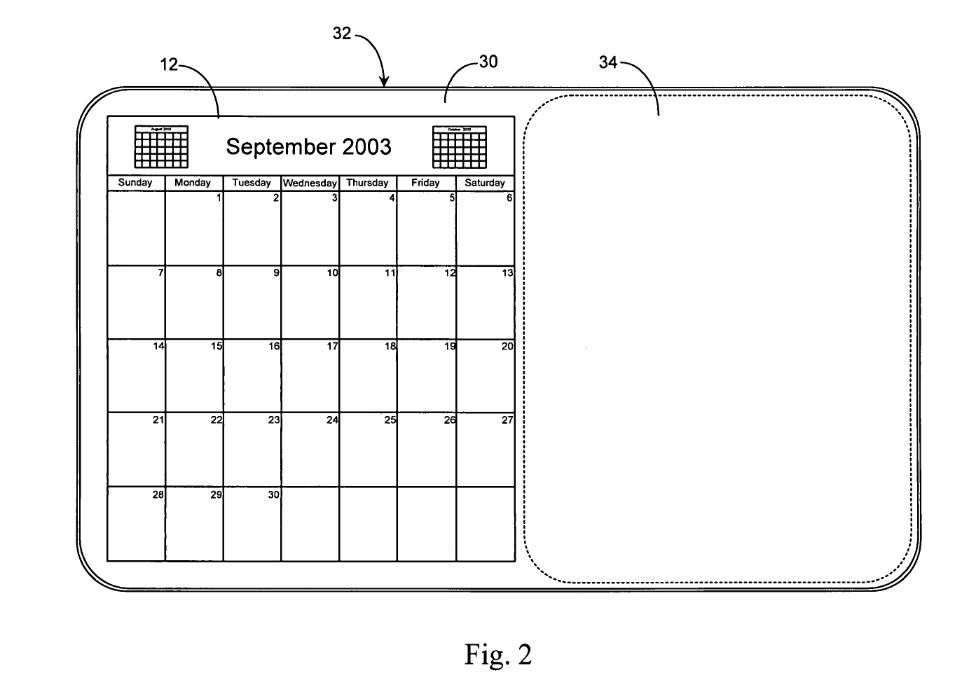

Referring now to FIG. 2, the top sheet 12 of the message board calendar 10 is shown adhered to the front surface 30 of an exemplary message board 32. In this example, the top sheet 12 is sized so that it will occupy only a portion of the front surface 30, such as between about one-third and two-thirds of the front surface. Accordingly, a portion 34 of the surface 30 will remain available for writing miscellaneous messages. Of course, the top sheet 12 could be sized so that it occupies substantially all of the surface 30. Also, the top sheet 12 could comprise an area separate from the calendar graphic 16 on which miscellaneous messages may be written.

In use of the message board calendar 10, a user simply selects the top sheet 12 having the calendar graphic 16 for the month or other period of time desired, peels the top sheet from the backing sheet 14, and adheres the top sheet to the surface 30 of the message board 32. The user may then use a dry-erase marker to write date-specific messages in the spaces 24 for the corresponding days of the month. At the end of the month, the user can simply peel the top sheet 12 off the message board 32 and discard it.

Referring again to FIG. 1, the message board calendar 10 may comprise a set which includes a plurality of top sheets 12, each of which is mounted on a corresponding backing sheet 14. In this embodiment, separate calendar graphics 16 representing, for example, corresponding months of a given year, may be printed on respective top sheets 12. Thus, the message board calendar 10 can include a separate monthly calendar for each month of a given year.

Furthermore, the backing sheets 14 may be bound together using, for example, a wire spiral 36. Thus, a set of monthly peel-and-stick message board calendars for, e.g., an entire year may be packaged together in a single message board calendar 10.

In addition, the message board calendar 10 may be provided with suitable means by which the message board calendar may be mounted on a wall or the like. For example, each backing sheet 14 may be provided with a central hole 38 through which a hook may extend. Thus, the message board calendar 10 may be mounted to a wall and itself used as a message board without the need to remove the top sheet 12 and adhere it to a separate message board.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

1. A peel-and-stick message board calendar which includes:
a top sheet which comprises a dry-erase surface and which is removably adherable to a dry-erase message board;
a backing sheet to which the top sheet is removably adhered; and
a calendar graphic which is disposed on the top sheet and which comprises a plurality of spaces and a plurality of numbers;
wherein each number represents an individual day of a corresponding period of time and is disposed in a corresponding one of the spaces; and
wherein the top sheet may be peeled from the backing sheet and adhered to the dry-erase message board.

2. The peel-and-stick message board calendar of claim 1, wherein the top sheet is comprised of a polymer material.

3. The peel-and-stick message board calendar of claim 2, wherein the top sheet is comprised of a vinyl film.

4. The peel-and-stick message board calendar of claim 2, wherein the top sheet is comprised of a static cling polymer material.

5. The peel-and-stick message board calendar of claim 1, wherein the calendar graphic is formed using a substantially non-erasable ink.

6. The peel-and-stick message board calendar of claim 1, further comprising a lamination layer which is disposed over at least a portion of the calendar graphic.

7. The peel-and-stick message board calendar of claim 1, wherein the area of the top sheet is less than the area of the dry-erase message board; whereby the dry-erase message board comprises a space on which messages may be written.

8. The peel-and-stick message board calendar of claim 7, wherein the area of the top sheet is between about one-third and two-thirds the area of the dry-erase message board.

9. The peel-and-stick message board calendar of claim 1, wherein the area of the top sheet is less than the area of the backing sheet, whereby the backing sheet comprises a space on which a message may be pre-printed.

10. A set of monthly peel-and-stick message board calendars which comprises:
a plurality of top sheets, each of which comprises a dry-erase surface and is adherable to a dry-erase message board;
a plurality of backing sheets, each of which comprises a surface to which a corresponding top sheet is removably adhered; and
a plurality of monthly calendar graphics, each of which corresponds to a specific month of a specific year and is disposed on a corresponding top sheet;
wherein each monthly calendar graphic comprises a grid of spaces and a plurality of numbers;
wherein each number represents an individual day of the corresponding month and is disposed in a corresponding one of the spaces; and
wherein the top sheets may be peeled from their corresponding backing sheets and adhered to the dry-erase message board.

11. The set of monthly peel-and-stick message board calendars of claim 10, wherein each top sheet is comprised of a polymer material.

12. The set of monthly peel-and-stick message board calendars of claim 11, wherein each top sheet is comprised of a vinyl film.

13. The set of monthly peel-and-stick message board calendars of claim 11, wherein each top sheet is comprised of a static cling polymer material.

14. The set of monthly peel-and-stick message board calendars of claim 10, wherein each calendar graphic is formed using a substantially non-erasable ink.

15. The set of monthly peel-and-stick message board calendars of claim 10, further comprising a lamination layer which is disposed over at least a portion of the calendar graphic.

16. The set of monthly peel-and-stick message board calendars of claim 10, wherein the area of each top sheet is less than the area of the dry-erase message board; whereby the dry-erase message board comprises a space on which messages may be written.

17. The set of monthly peel-and-stick message board calendars of claim 16, wherein the area of each top sheet is between about one-third and two-thirds the area of the dry-erase message board.

18. The set of monthly peel-and-stick message board calendars of claim 10, wherein the area of each top sheet is less than the area of its corresponding backing sheet, whereby the backing sheet comprises a space on which a message may be pre-printed.

19. The set of monthly peel-and-stick message board calendars of claim 10, further comprising means for securing the backing sheets together.

20. The set of monthly peel-and-stick message board calendars of claim 10, further comprising means for suspending the backing sheets from a wall.
